(19) United States
(12) Patent Application Publication
(10) Pub. No.: US 2019/0057411 A1
(43) Pub. Date: Feb. 21, 2019

(54) DIGITAL ADVERTISING MEDIUM

(71) Applicant: Adam Hunt, Las Cruces, NM (US)

(72) Inventor: Adam Hunt, Las Cruces, NM (US)

(21) Appl. No.: 16/104,937

(22) Filed: Aug. 19, 2018

Related U.S. Application Data
(60) Provisional application No. 62/547,812, filed on Aug. 19, 2017.

(51) Int. Cl. G06Q 30/02; G06Q 50/00; G06Q 10/10

(52) U.S. Cl. CPC G06Q 30/0214; G06Q 10/103; G06Q 50/01

(57) ABSTRACT

A system to utilize at least one of a website and a mobile application that is used by a company to provide monetary compensation to employees who advertise the company on social media, the system including a first computer utilized by at least one of the employees to access the at least one of the website and the mobile application, which accesses a social medium to allow the at least one of the employees to advertise the company by posting an advertisement on the social medium, and a second computer utilized by an employer to access the at least one of the website and the mobile application to approve the advertisement prior to the posting becoming publicly viewable on the social medium, and to provide the monetary compensation to the at least one of the employees using the first computer.

### CROSS REFERENCE TO RELATED APPLICATIONS

This application claims the benefit of U.S. Provisional Patent Application No. 62/547,812, filed Aug. 19, 2017 and entitled “DIGITAL ADVERTISING MEDIUM,” the entire disclosure of which is incorporated herein by reference.

### BACKGROUND OF THE INVENTION

### 1. Field

The present general inventive concept relates generally to a system running and accessing a website and/or mobile application that can be used by a company to provide compensation to employees who advertise the company on social media.

### 2. Description of the Related Art

In the modern age of technology, social media has become a largely-utilized platform for marketing businesses. Many employees may freely promote their place of work on their personal sites to encourage family and friends to visit. For example, when a person obtains a new position at a new place of employment, he/she can update a resume on LINKED IN, such that all of his/her friends are notified of the new position. However, such advertisement provides an income of revenue to the employer directly without providing compensation to the employee.

Therefore, there is a need for a website and/or mobile application that allows employees to advertise their places of employment, while providing compensation for the employees' advertising efforts.

### SUMMARY

The present general inventive concept provides a website and/or application that monitors an employee's social media to determine an amount of advertising the employee has provided to advertise a business where the employee works, while providing a method for the employee to be compensated for the advertisement.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system to utilize at least one of a website and a mobile application that is used by a company to provide monetary compensation to employees who advertise the company on social media, the system including a first computer utilized by at least one of the employees to access the at least one of the website and the mobile application, which accesses a social medium to allow the at least one of the employees to advertise the company by posting an advertisement on the social medium, and a second computer utilized by an employer to access the at least one of the website and the mobile application to approve the advertisement prior to the posting becoming publicly viewable on the social medium, and to provide the monetary compensation to the at least one of the employees using the first computer.

The second computer may allow the employer to directly deposit the monetary compensation to a bank account of the at least one of the employees via the at least one of the website and the mobile application.

The at least one of the employees may receive a predetermined number of points for each approve advertisement, such that the predetermined number of points are equivalent to a predetermined amount of the monetary compensation.

The at least one of the website and the mobile application may be linked directly to the social medium such that it is accessible directly from the social medium.

The social medium may be at least one of FACEBOOK, MYSPACE, TWITTER, LINKEDIN, INSTAGRAM, PINTEREST, TUMBLR, YOUTUBE, FLICKR, REDDIT, SNAPCHAT, and WHATSAPP

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 is a block diagram illustrating a system running and accessing a website and/or mobile application that can be used by a company to provide compensation to employees who advertise the company on social media.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

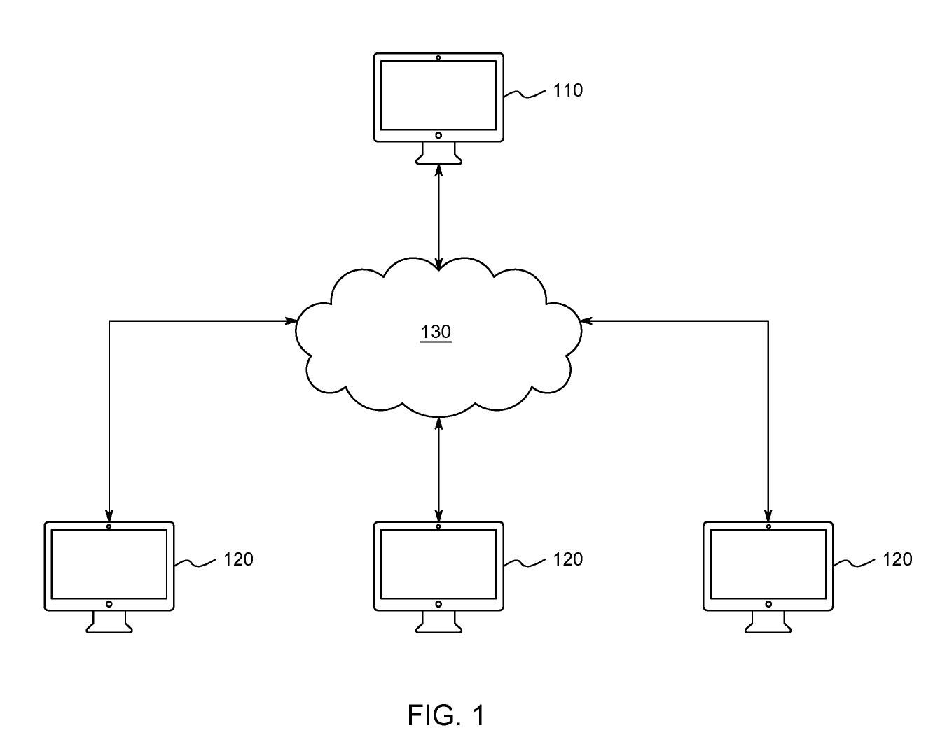

FIG. 1 is a block diagram illustrating a system 100 running and accessing a website and/or mobile application that can be used by a company to provide compensation to employees who advertise the company on social media.

The system 100 may include a first computer 110, a second computer 120, and a network 130, but is not limited thereto.

A digital advertising medium may be a website and/or application that may be accessed using a computer 110 such as a desktop computer, a laptop computer, a tablet computer, or any other type of computing device, or a mobile device, such as a smart phone, a palm pilot, a BLACKBERRY, or any other type of hand-held device. All of the above devices may have an ability to access the Internet via any available wired or wireless technology, and may include components such as a display device (e.g., touch screen, LED, LCD, plasma, etc.), an input unit (e.g., keyboard, touchpad, mouse, etc.), a camera (e.g., video camera, still camera, etc.), a processor, a storage unit, a communication unit, and an output unit (i.e., speakers, etc.).

A business owner may download the digital advertising medium to at least one computer and/or mobile device 110, and then enroll his/her company into the digital advertising medium. The enrollment would preferably be contractual, and any employers/employees linked with the digital advertising medium would be bound to a contract of advertising/receiving-compensation.

A user may sign up for the digital advertising medium at a home page of the digital advertising medium, and/or may download an application of the digital advertising medium. Employees may log-in from their private mobile devices 120 and begin advertising on various social media platforms. As a result, the employees may work harder to promote the employer's business due to the added received compensation from the social media advertisements, which also ultimately brings in a bigger influx of income and clientele to employers based directly on staff efforts.

The computer 110 and the computers 120 may communicate with each other via the network 130, which may include the Internet, Intranet, WIFI, 3G, 4G, or any other communication network known to one of ordinary skill in the art.

The digital advertising medium may access the user's social media platforms, such as FACEBOOK, MYSPACE, TWITTER, LINKEDIN, INSTAGRAM, PINTEREST, TUMBLR, YOUTUBE, FLICKR, REDDIT, SNAPCHAT, WHATSAPP, etc., but is not limited thereto. As such, the digital advertising medium may be linked to the user's social media in real time.

Accordingly, when the user advertises a place of employment/business on a social medium, the digital advertising medium may receive a notification from the social medium that the advertisement has been created by the user, and may generate a predetermined number of points that may be stored in an account for the user. The points may be used by the user to receive monetary compensation from an employer.

Different point values may be assigned to different type of advertisements. For example, a video advertisement may receive ten points, a picture advertisement may receive only five points, and a comment may receive only one point.

The employer may choose to optionally approve or disapprove the user's advertisements. More specifically, an employer may choose to be notified when an advertisement is made on the user's social media, and then may approve the advertisement before it is posted publicly. Once the advertisement is approved, the points are awarded to the user. Alternatively, if the employer does not choose to approve the advertisements of his employees, the user may receive the points directly after the advertisement is posted, in real time.

The point values may be directly related to dollar amounts. For example, one point may be worth ten cents. As such if the user accumulates 100 points, then the user would be entitled to receive ten dollars from the employer.

Also, the employer may choose to place a limit on an amount of advertisements users may post each month, and/or points that users may accumulate each month, in order to prevent overuse or abuse of the digital advertising medium.

Further, the employer may assign monetary values to the points, so that the employer can control and modify an amount of compensation that an employee is able to receive based on the employer's preference.

To further calculate additional compensation that each employee may receive, business patrons may fill out a questionnaire and/or survey, and may also post pictures or comments regarding their visit. This may enable the patrons to inform owners as to which employee informed them of the business, and through which social media network, adding points to the employee's account on the digital advertising medium. These points may be tallied along with the points related to the other advertisements (e.g., posts, images, and videos made on the staff member's sites) resulting in a calculated compensation amount that can be used to receive compensation from the employer.

For example, when a customer visits a restaurant based on an employee's advertisements, a tableside tablet computer may allow the customer to immediately access the digital advertising medium in the restaurant (which may have a list of employees that work at the restaurant), and provide verification of patronage. For instance, the customer may take a photo of a receipt as proof of visiting the restaurant, and send the photo, along with the name of the employee, to the employer. As a result, the employee may receive a commission as a percentage of an amount the customer purchased.

Since not all people on social media will be able to physically visit the various advertised businesses/restaurants due to distance, the digital advertising medium may also monitor whether a user clicked on a link to a website of the business from the employee's social media site. Therefore, the employee may receive compensation from the link-click, and/or commissions from any online purchases resulting from the link-click. For example, if a customer clicks on a link to a restaurant's website from an employee's FACEBOOK page, the digital advertising medium tracks and records the link-click, and then monitors whether the customer places an order for t-shirts, shippable food, and/or simple donations directly for the employee.

The digital advertising medium can have a direct deposit option to allow the employer to provide compensation directly to the employer via the digital advertising medium. This direct deposit option may be manual or automatic, and thus, the employer may have the option of approving the point compensation awarded, or may allow the user to receive the compensation on a certain day each month.

Also, the digital advertising medium may be directly linked to the employer's operating account, as well as the employees' bank accounts, to facilitate funds transfers.

The digital advertising medium is the only Internet-based application of its kind that motivates employees to advertise where they work, offering a second form of income to employees, while also increasing the income of revenue for businesses by attracting new customers. The digital advertising medium is uniquely designed to potentially permit companies to have online stores where consumers can buy items or make donations to support businesses and their staff in the event the patron is unable to make in-store visits. In addition, the online store may have an option to annotate employee referrals as an individual is making their purchase, in order to give commissions to the employee at a point of sale.

As a result, employees may receive payment from a regular wage, as well as payment from work they do after-hours on social media. The employees may get paid on how many social media networks they use, how many comments they post in a pay period, and/or how many people they bring into the business. Therefore, the employees will work harder not only in the restaurant, but also after-hours to bring business into the establishment. Also, it is believed that the community will want to support the restaurant staff, which may be working to get through college, thereby further helping support the community and its quest for education.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system to utilize at least one of a website and a mobile application that is used by a company to provide monetary compensation to employees who advertise the company on social media, the system comprising:
a first computer utilized by at least one of the employees to access the at least one of the website and the mobile application, which accesses a social medium to allow the at least one of the employees to advertise the company by posting an advertisement on the social medium; and
a second computer utilized by an employer to access the at least one of the website and the mobile application to approve the advertisement prior to the posting becoming publicly viewable on the social medium, and to provide the monetary compensation to the at least one of the employees using the first computer.

2. The system of claim 1, wherein the second computer allows the employer to directly deposit the monetary compensation to a bank account of the at least one of the employees via the at least one of the website and the mobile application.

3. The system of claim 2, wherein the at least one of the employees receives a predetermined number of points for each approve advertisement, such that the predetermined number of points are equivalent to a predetermined amount of the monetary compensation.

4. The system of claim 1, wherein the at least one of the website and the mobile application is linked directly to the social medium such that it is accessible directly from the social medium.

5. The system of claim 1, wherein the social medium is at least one of FACEBOOK, MYSPACE, TWITTER, LINKEDIN, INSTAGRAM, PINTEREST, TUMBLR, YOUTUBE, FLICKR, REDDIT, SNAPCHAT, and WHATSAPP.
